(19) United States
(12) Patent Application Publication
(10) Pub. No.: US 2001/0014551 A1
(43) Pub. Date: Aug. 16, 2001

(54) PLUG-IN MODULE WITH INSTALLATION GUIDE, RETENTION FEATURE, AND HANDLE

(76) Inventors: STEVEN E. BLASHEWSKI, DULUTH, GA (US); ANDREW F. MCCANN, LAWRENCEVILLE, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/357,719

(22) Filed: Jul. 21, 1999

Related U.S. Application Data
(63) Continuation-in-part of application No. 09/170,461, filed on Oct. 13, 1998, now abandoned.

(51) Int. Cl. H01R 13/64

(52) U.S. Cl. 439/378; 439/247; 439/248; 439/680

(57) ABSTRACT

A plug-in module (100) for electronic equipment (425) includes circuitry (140) for processing electrical signals, a housing (400) for at least partially enclosing the circuitry (140), and at least one electrical pin (115) extending from a bottom surface of the housing (400), coupled to the circuitry (140), and having a first length. The module (100) also includes an installation guide (420) extending from the bottom surface of the housing (400) and having a second length greater than the first length such that, as the plug-in module (100) is inserted into a receiving member (125) of a substrate (120) to which it is to be mounted, the installation guide (420) contacts the receiving member (125) before the at least one electrical pin (115) contacts a receptacle (130) so that the pin (115) is guided into the receptacle (130). A handle (410) extending from a top surface of the housing (400) so that, when the plug-in module (100) is mounted in an electronic device (600) having a cover (620), the handle (410) extends through a hole (625) formed in the cover (620).

### RELATED APPLICATION

This application is a continuation-in-part of U.S. patent application Ser. No. 09/170,461 (Attorney's Docket No. A-4996) to Blashewski et al., filed on Oct. 13, 1999 and assigned to the assignee hereof.

### FIELD OF THE INVENTION

This invention relates generally to plug-in modules, modules, and accessories, and more specifically to plug-in accessories that, once inserted into a receptacle, make an electrical connection.

### BACKGROUND OF THE INVENTION

Electronic equipment, such as cable television amplifiers and taps, often includes a number of electrical accessories, such as components and modules. Some of these accessories, such as attenuator pads and directional couplers, must be replaced or changed from time to time. For example, an attenuator pad or coupler may need to be replaced with a device having a different electrical loss value if a cable television tap is moved further downstream in a cable television distribution system. For those devices that are replaced often, plug-in modules are often used. A plug-in module, such as a plug-in directional coupler, is generally a self-contained unit that includes one or more electrical components included therein as well as one or more electrical pins extending therefrom. The pins plug into corresponding sockets of the equipment that is to receive the plug-in module.

Problems with plug-in modules can occur, however, when a module is misaligned or inserted improperly. These problems include damage to the module pins, damage to sockets or other devices that a plug-in module improperly contacts, or even electrical malfunctions that can result from insertion of module pins into improper sockets. The likelihood of such problems occurring increases when module pins are thin, and therefore easily bent, or when module pins are symmetrically positioned so that installation of the module backwards, and thus reversal of the pins, is possible.

A further problem with existing plug-in modules is that they are susceptible to environmental conditions such as vibration and temperature extremes. These types of conditions often cause plug-in modules to loosen from or even completely detach from the equipment in which they are installed.

In addition, communication equipment often includes covers that restrict access to their printed circuit boards and related electronics. Holes are typically provided in these covers for the insertion and removal of detachably mounted plug-in modules, such as equalizers and attenuator pads. Installing accessories through these holes can be difficult, however, since many of the accessory plug-in modules fit completely below the level of a cover once fully installed. Gripping and manipulating a plug-in module, once it is below the level of a cover, is problematic and often results in misalignment of the plug-in module and/or equipment damage.

Removing plug-in modules from equipment through holes in the equipment covers is no easier. A technician must reach through the cover hole, grip the module, and forcefully pull it out through the hole, which is usually only slightly larger than the plug-in module itself. Special tools can be used to remove a plug-in module through its corresponding hole in the device cover, but often the module and/or the tool can become hung on the cover or other device components, causing the plug-in module to drop down into the equipment beneath its cover. Removal of the device cover may then be required to retrieve the dropped plug-in module. Furthermore, if the cover hole is large enough and the removal tool is small enough, the tool itself could drop down into the equipment beneath its cover. Under the best of circumstances, keeping up with the different types of tools required to insert and remove different types of plug-in modules can be problematic.

Thus, there exists an opportunity to provide a plug-in module that can be more reliably and more easily installed within and removed from electronic equipment.

### BRIEF DESCRIPTION OF THE DRAWINGS

FIG. 1 is a side view of a plug-in module with an installation guide in accordance with the present invention.

FIG. 2 is a side view of a plug-in module with an installation guide and retention features in accordance with the present invention.

FIG. 3 is a side view of a plug-in module having an installation guide and retention feature, after insertion into a printed circuit board, in accordance with the present invention.

FIGS. 4 and 5 are perspective views of plug-in modules having handles in accordance with the present invention.

FIG. 6 is an exploded view of assembly of the plug-in module of FIG. 4 into a device having a cover in accordance with the present invention.

FIG. 7 is a perspective view of electronic equipment in which the plug-in module of FIG. 4 can be mounted through a hole in a cover in accordance with the present invention.

FIG. 8 is an electrical block diagram of a communication system that can included electronic equipment incorporating the plug-in module of FIGS. 1-5 in accordance with the present invention.

### DETAILED DESCRIPTION OF A PREFERRED EMBODIMENT

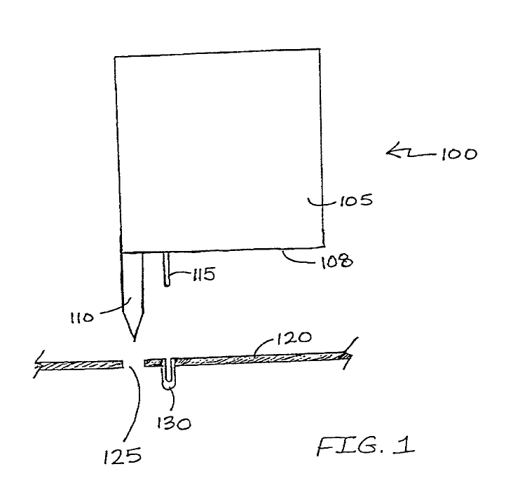

FIG. 1 shows a plug-in module 100 that can be used in any electronic equipment having parts that are often replaced. For example, the plug-in module 100 can be a plug-in directional coupler or attenuator pad that is part of a distribution amplifier or a tap in a cable television system. The module 100 includes circuitry (not shown) for processing electrical signals, a housing 105 for at least partially enclosing the circuitry, and, sometimes, a printed circuit board or other substrate upon which the circuitry can be mounted, if necessary. At least one electrical pin 115 extends from a bottom surface 108 of the housing 105 for detachably coupling with an electrical socket 130 mounted to a receiving member, such as a substrate 120 or printed circuit board that is located within electronic equipment.

According to the present invention, the plug-in module 100 further includes an installation guide 110 for guiding the plug-in module 100 during insertion into the electronic equipment such that the electrical pins 115 are properly aligned with and inserted into their respective sockets 130. The guide 110 is preferably longer than the pin 115 or pins 115 so that, when the module 100 is moved into contact with the substrate 120, the guide 110 makes physical contact with the substrate 120 before the pins 115 contact any part of the electronic equipment in which the substrate 120 is mounted. More specifically, as the module 100 is moved in a downward direction towards the substrate 120, the installation guide 110 is pushed through an aperture 125 formed in the substrate 120. Once this occurs, continued downward force results in the proper insertion of the electrical pins 115 into their respective socket 130, thereby providing a properly inserted plug-in module 100 that is both mechanically and electrically secured to the substrate 120. As shown, the guide 110 can, at its distal end, be formed into a point or other shape with a relatively small circumference so that insertion into the aperture 125 does not require precise operations on the part of a human operator or machinery.

Preferably, the guide 110 is formed from an electrically insulating material so that, when the plug-in module 100 is misaligned, guide contact with the substrate 120 does not result in electric connections that could damage the module 100, the substrate 120, or other modules of the electronic equipment that the guide 110 may physically or electrically contact. It will be appreciated, however, that, if desired, the installation guide 110 could be electrically conductive so that a further electrical connection is provided between circuitry of the substrate 120 and circuitry of the module 100. For instance, the installation guide 110 could be electrically coupled to a ground plane when inserted into the aperture 125.

In order to provide a relatively strong installation guide 110, it is also preferred that the guide 110 be integrally formed with the housing 105, although a separately formed guide 110 subsequently secured to the housing, such as by gluing, riveting, or soldering, could alternatively be used. A stronger installation guide 110 can also be provided by increasing the width of the guide 110 so that improper insertion attempts do not deform or break the guide 110.

It will be appreciated that, although only a single guide 110 and a single pin 115 are depicted in FIG. 1, greater numbers of guides 110 and pins 115 can be included as necessary. Preferably, the number of pins 115 is dictated by the electrical nature of the module 100, while the number of installation guides 110 is dictated by factors such as likelihood of improper module insertion, strength of electrical pins 115, and types of environmental conditions to which the electronic equipment is subjected, among others. When, for instance, walls or other modules of the electronic equipment would prevent the module 100 of FIG. 1 from being turned in any other direction from that shown, the single installation guide 110 may be sufficient. If, on the other hand, there are no other equipment features that would prevent misalignment of the module 100, additional guides 110 might be necessary to prevent an operator from turning the module 100 about the longitudinal axis of the guide 110 and pushing downwards until the pin 115 contacts the substrate 120 in an improper location.

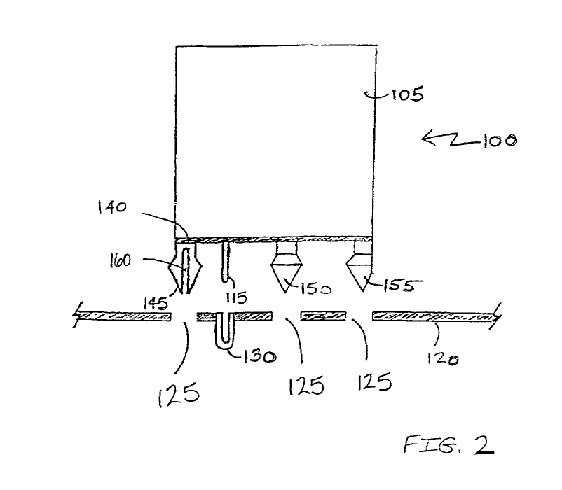

Referring next to FIG. 2, the plug-in module 100 is shown as including installation guides 145, 150, 155 that include various retention features that secure the module 100 to the substrate 120 according to the present invention. Guide 150 includes a pointed lower end that slopes outward, in the shape of a cone, to a wider middle portion, which then slopes back inward to the post of guide 150, which has a smaller circumference than does the widest region of the middle portion. When the module 100 is pushed downward into contact with the substrate 120, the lower end of guide 150 extends through the aperture 125, which preferably has a circumference only slightly smaller than that of the middle portion of guide 150. As a result, continued downward forced deflects guide material that is inserted through the aperture 125 so that the middle portion of guide 150 can be pushed through the aperture 125. The upper portion, i.e., the post, of guide 150, which has a circumference equal to or smaller than the aperture 125, is seated within the aperture 125 to hold the module 100 to the substrate 120.

Guide 155 is similar to guide 150, but one lengthwise surface of guide 155 is formed parallel with the side surface of the housing 105 and is not angled. As a result, the middle portion of guide 155 can be deflected to a greater extent than can the middle portion of guide 150; therefore, guide 155 is slightly easier to insert into the aperture 125 than is guide 150.

Guide 145 is also similar to guide 150. However, guide 145 includes a longitudinal opening 160 through the core of guide 145. Therefore, guide 145 can be more easily inserted through the aperture 125 than can guide 150, since the material of guide 145 can be deflected inward during insertion of the module 100 into its receiving members.

It should be noted that guides 145, 150, 155 can all include an inwardly sloped surface from the larger circumference middle portion to the smaller circumference guide post, thereby providing for the removal of the module 100 from the substrate 120 upon application of an upward force on the module 100.

FIG. 2 also shows that the plug-in module 100 can include its own substrate, or printed circuit (pc) board 140 upon which internal circuitry can be mounted in a conventional manner. In such an embodiment, the housing 105, the guides 145, 150, 155, and the electrical pin or pins 115 can be mounted to the pc board 140 rather than integrally formed together. Alternatively, the housing 105 and guides 145, 150, 155 could be integrally formed to snap in place around the board 140 on which circuitry and pins 115 are mounted.

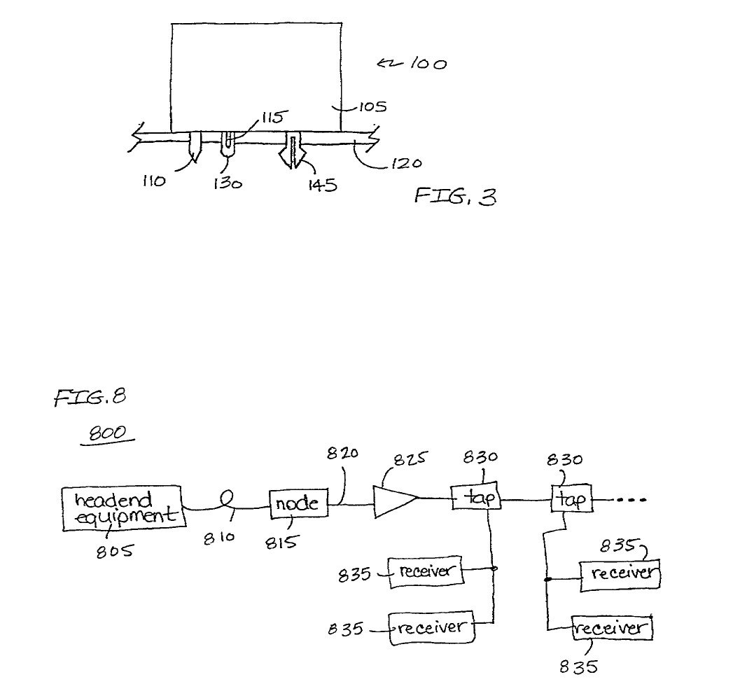

Referring next to FIG. 3, the plug-in module 100 is depicted after mounting to the substrate 120. In this illustration, it can be seen that, once the longer guides 110, 145 are pushed through their respective apertures in the substrate 120, the pin 115 is naturally guided into and seated within the electrical socket 130. In this manner, the plug-in module 100 can be properly mounted without damage to the module 100, its pin or pins 115, or the electronic equipment into which it is installed.

As described above, each of FIGS. 1-3 shows a variety of different installation guides, both with and without retention features, and variety of different configurations. It should be appreciated that the plug-in module 100 can include any combination of the described guides and retention features without departing from the scope of the teachings herein, and that other form factors for installation guides and retention features are considered to be within the scope of the claims of this patent application. For instance, there is no requirement that the retention features include a gradual slope from the middle region, i.e., the widest region, back up to the narrower post that is proximal the housing of the module or that the installation guides slide through apertures on a substrate as opposed to other types of receiving members.

As mentioned, environmental factors can also influence the number and locations of the guide or guides of module 100. When, for instance, electronic equipment including the plug-in module 100 is a cable television amplifier, the amplifier may be mounted on a utility pole in the outdoors, and therefore subjected to a number of different extreme conditions. In such a situation, the cable television amplifier is expected to withstand both sharp blows and vibration, and an advantage of the plug-in module 100 described herein is that the guides provide a retaining feature that is absent in prior art plug-in devices. As a result, the module 100 remains mounted properly and continues to function without interruption even when exposed to environmental conditions that could render conventional plug-in devices inoperable.

As mentioned briefly in the above Background of the Invention, some types of electronic devices, such as cable television system and broadband network equipment, include covers that limit access to their printed circuit boards or substrates on which plug-in modules and other electronic components can be mounted. These covers typically have holes over the substrate locations where plug-in modules are positioned so that these plug-in modules can be removed and replaced without exposing the substrate and other device electronics to the environment.

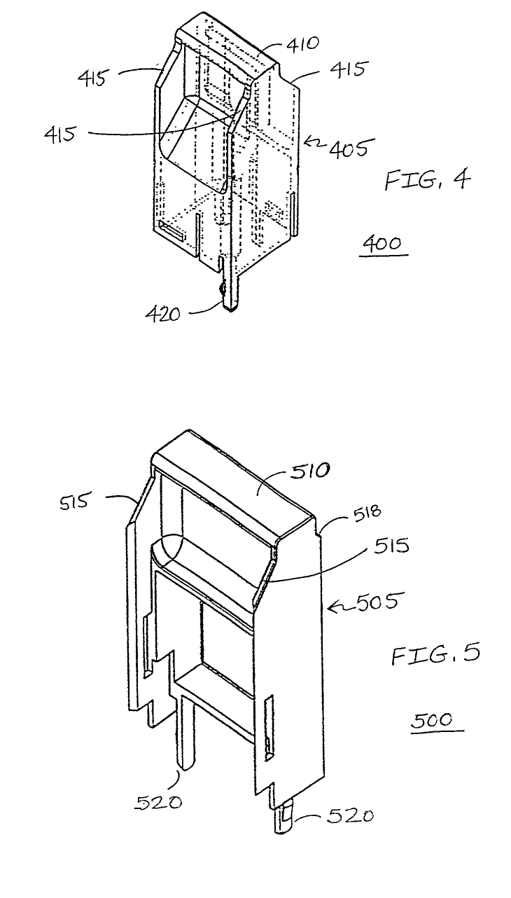

FIGS. 4 and 5 illustrate two accessory housing designs that can be used to house plug-in modules which are repeatedly inserted into and removed from electronic devices through holes in the device covers. FIG. 4 depicts a plug-in module housing 400 that accepts a horizontally mounted printed circuit board or substrate that has mounted thereto circuitry and electrical pins (not shown) similar to those discussed with reference to FIGS. 1-3. Housing 400 includes a body portion 405 in which the circuitry of the printed circuit board or substrate is contained and a handle 410 that, when the module is plugged into an electronic device, extends through a hole formed in the cover of the electronic device. The handle 410 can be gripped by a technician during insertion or removal of the plug-in module. Preferably, the handle 410 extends from a top surface of the housing 405 opposite the bottom surface from which installation guides 420 and/or electrical pins (not shown) extend. The handle 410 may be integrally formed as a part of the housing 400, as shown, or coupled thereto by a fastening mechanism, such as a screw or rivet. When the cover of a device into which the housing 400 is plugged is electrically conductive, the handle 410 should be electrically insulative or covered with an insulating material in locations that may contact the cover.

Housing 400 further includes members 415 that slope from the narrower handle 410 to the wider body portion 405 of the housing 400. Mechanical installation guides 420 can be integrally formed as a part of the housing 400 or coupled thereto by other fastening mechanisms, e.g., screws, rivets, soldering, etc.

Preferably, the body portion 405 of the housing 400 fits relatively snugly into its corresponding hole in the cover of the device into which plug in module is installed. This assists in guiding the plug-in module into its correct location and also prevents excessive movement of the module which could result in damage to surrounding areas of the device. Properly sizing the body portion 405 of the housing 400, as described above, can also prevent the plug-in module from inadvertently being dropped into the electronic device beneath its cover before the module has correctly engaged the device substrate. Another advantage of the housing 400 is that its sloping members 415 prevent the plug-in module from becoming hung beneath the device cover during its removal from the electronic device. As a result, insertion and removal of the plug-in module can be performed quickly and reliably, even for a device that employs a cover that limits access to the device electronics.

Referring next to FIG. 5, a second housing design 500 is shown. Module housing 500 is narrower than housing 400 of FIG. 4. This narrower housing 500 is suitable for holding and containing within its housing body 505 a vertically mounted printed circuit board or other substrate (not shown) and its related circuitry. Housing 500 also includes mechanical installation guides 520, a handle 510 that is narrower than the body 505, and sloping members 515, 518 for connecting the handle 510 to the body portion 505 of the housing 500.

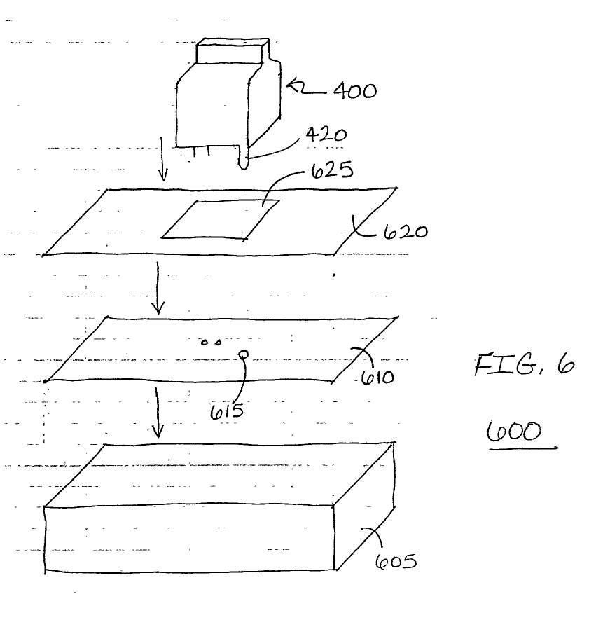

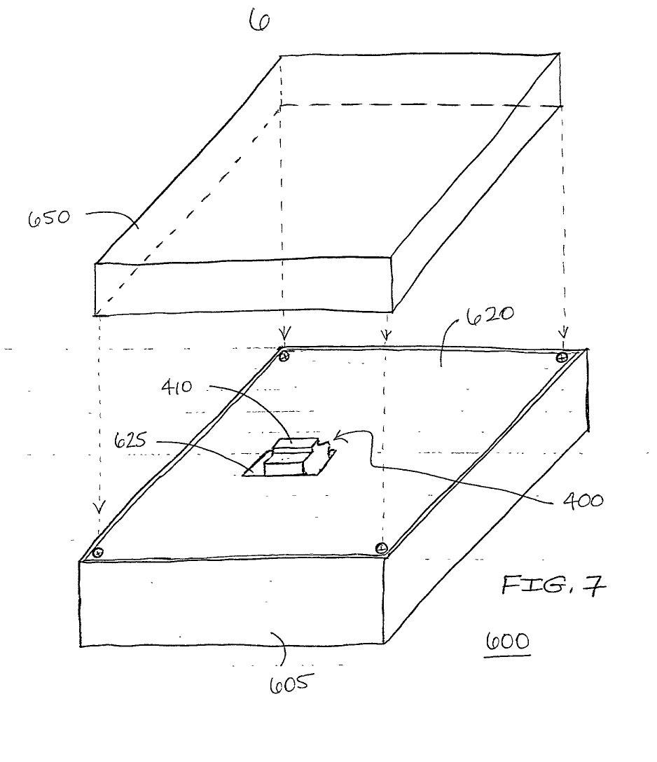

FIGS. 6 and 7 show an electronic device 600 into which a plug-in module including the housing 400 of FIG. 4 or the housing 500 of FIG. 5 can be installed. For illustration purposes only, FIGS. 6 and 7 are shown and described with reference to the housing 400 of FIG. 4.

The electronic device 600 (FIGS. 6 and 7) generally includes a housing 605 in which a substrate 610, such as a printed circuit board, is mounted. Once the substrate 610 and electronic components mounted thereto are positioned within the electronic device 600, the cover 620 is installed by fastening it to the housing 605. A plug-in module having the module housing 400 can then be inserted through the hole 625 formed in the cover 620 so that the electrical pins and installation guides 420 mate with the corresponding receiving members 615 formed on or in the substrate 610. As shown in FIG. 7, a device lid 650 may then be fastened to the device housing 605 to prevent access to all internal electronics, including any plug-in modules, of the electronic device 600.

FIG. 8 is an electrical block diagram showing a broadband communication system, such as a cable television system 800, that includes different elements that could incorporate the plug-in module 100, 400, 500. The system 800 includes headend equipment 805 for transmitting signals, such as optical signals that are sent over fiber optic cable 810 for conversion into electrical signals by an optical node 815. The electrical signals are then routed over another medium, such as coaxial cables 820, where they may be amplified by distribution amplifiers 825 then split off to subscriber receiving equipment 835 by cable taps 830. Any or all of these types of electronic equipment may include plug-in modules that are manufactured in accordance with the present invention. In particular, attenuator pads, fuses, equalizers, signal directors, and other frequently replaced devices could be manufactured as plug-in modules having installation guides, retention features, and handles as described herein.

In summary, the plug-in module of the present invention includes at least one electrical pin that is shorter than one or more installation guides that extend from the same surface of the module. In this manner, when the module is inserted into electronic equipment, the installation guides make contact with a substrate of the equipment before the pins do. If an attempt has been made to improperly insert the module, the physical contact between the guides and the substrate or other device will hold the module away from the substrate, preventing contact between the pins and the substrate that could damage the module or the equipment into which it is being inserted. On the other hand, proper alignment between the module and the substrate of the equipment will result in the guides being pushed into their respective receiving members such that the pins are guided into proper contact with their respective sockets. Retention members optionally formed on the installation guides can then secure the module within the electronic equipment.

The plug-in module of the present invention can also include a handle that extends through a hole formed in the cover of the electronic equipment in which the module is mounted. The handle permits a technician to easily grasp the plug-in module from outside the equipment cover and to easily install and remove the plug-in module without the use of special tools. Furthermore, the handle and body shape of the plug-in module provides an additional guidance feature for properly aligning the electrical pins and mechanical guide posts with their corresponding receiving members on the substrate into which the module is to be installed.

It will be appreciated by now that there has been provided a plug-in module that can be more reliably and more easily installed within and removed from electronic equipment.

What is claimed is:

1. A plug-in module, comprising:
circuitry;
a housing for at least partially enclosing the circuitry;
at least one electrical pin extending from a bottom surface of the housing and coupled to the circuitry, the at least one electrical pin having a first length;
an installation guide extending from the bottom surface of the housing and having a second length greater than the first length such that, as the plug-in module is inserted into a receiving member, the installation guide contacts the receiving member before the at least one electrical pin contacts an electrical socket such that the at least one electrical pin is guided into the electrical socket; and
a handle extending from a top surface of the housing, wherein the handle extends through a hole formed in a cover that limits access to an electronic device in which the plug-in module is mounted.

2. The plug-in module of claim 1, wherein the handle is integrally formed with the housing.

4. The plug-in module of claim 1, wherein the handle is electrically insulative.

5. The plug-in module of claim 1, further comprising:
a substrate on which the circuitry is mounted, the substrate including an upper surface to which the housing is coupled and a lower surface, opposite the upper surface, to which the installation guide is coupled.

6. The plug-in module of claim 5, wherein the housing of the plug-in module includes a body portion for enclosing the substrate.

7. The plug-in module of claim 6, wherein the body portion of the housing is wider than the handle.

8. The plug-in module of claim 7, further comprising:
sloped surfaces for connecting the handle to the body portion of the housing.

9. Electronic equipment for processing signals, the electronic equipment comprising:
a substrate including a receiving member and an electrical socket;
a device housing in which the substrate is mounted;
a plug-in module for mounting to the substrate, the plug-in module comprising:
a module housing;
at least one electrical pin extending from a bottom surface of the module housing, the at least one electrical pin having a first length;
an installation guide extending from the bottom surface of the module housing such that, as the plug-in module is plugged into the substrate, the installation guide contacts the receiving member and guides the at least one electrical pin into the electrical socket; and
a handle extending from the top surface of the module housing; and
a device cover mounted to the device housing for at least partially covering the substrate, the device cover having a hole formed therein, wherein the hole is aligned with the plug-in module so that the plug-in module can plugged into and removed from the substrate via the hole, and wherein the handle of the plug-in module extends through the hole when the plug-in module is mounted to the substrate.

10. The electrical equipment of claim 9, wherein the installation guide is integrally formed with the module housing.

11. The electrical equipment of claim 9, wherein the installation guide is electrically insulative.

12. The electrical equipment of claim 9, wherein the handle is integrally formed with the module housing.

13. The electrical equipment of claim 9, wherein the handle is electrically insulative.

14. The electrical equipment of claim 9, wherein the plug-in module further comprises:
circuitry that is at least a partially enclosed by the module housing; and
another substrate on which the circuitry is mounted, the other substrate including an upper surface to which the module housing is coupled and a lower surface, opposite the upper surface, to which the installation guide is coupled.

15. The electrical equipment of claim 14, wherein the module housing of the plug-in module comprises a body portion in which the other substrate is mounted.

16. The electrical equipment of claim 15, wherein the body portion of the plug-in module is wider than the handle of the plug-in module.

17. The electrical equipment of claim 16, wherein the plug-in module further comprises:
sloped surfaces for connecting the body portion of the plug-in module to the handle.

18. The electrical equipment of claim 16, wherein the body portion of the plug-in module is sized to fit within the hole formed in the cover.

19. The electrical equipment of claim 16, wherein the electrical equipment is a communication system amplifier.

20. The electrical equipment of claim 17, wherein the electrical equipment is included within a broadband communication system.
